(19) United States
(12) Patent Application Publication
(10) Pub. No.: US 2009/0235703 A1
(43) Pub. Date: Sep. 24, 2009

(54) ELECTRICAL LOCK APPARATUS

(76) Inventor: Gab-Sik Kim, Seoul (KR)

Correspondence Address: BIRCH STEWART KOLASCH & BIRCH, PO BOX 747, FALLS CHURCH, VA, 22040-0747, US

(21) Appl. No.: 11/909,443

(22) PCT Filed: Mar. 23, 2006
(86) PCT No.: PCT/KR06/01054

§ 371 Date: Sep. 21, 2007

(30) Foreign Application Priority Data
Mar. 24, 2005 (KR) 10-2005-0024458

(51) Int. Cl. E05B 49/00

(52) U.S. Cl. 70/283.1

(57) ABSTRACT

Disclosed is an electrical lock apparatus in which protrusions are formed at constant angles in a key head of a key provided with a chip and grooves are formed in an input socket to allow the protrusions to be inserted into the input socket, whereby the input socket can be rotated by turning the key inserted into the input socket. In an electric lock apparatus including a key having a key head provided with inner and outer terminals of a hemispherical shape, and an input socket into which the key head is inserted, having grooves provided with terminals being in contact with the inner and outer terminals of the key head, the electric lock apparatus comprises protrusions formed to surround the key head, and grooves formed at the grooves of the input socket to allow the protrusions to be respectively inserted thereinto, whereby the input socket is rotated as the key is rotated in a state that the key head is inserted into the input socket.

### TECHNICAL FIELD

The present invention relates to an electrical lock apparatus, and more particularly, to an electrical lock apparatus in which protrusions are formed at constant angles in a head of a key provided with a chip and grooves are formed in an input socket of a lock apparatus to which the key head is inserted, so that the protrusions can be inserted into the grooves, thereby rotating the key in a state that the key is inserted into the input socket.

### BACKGROUND ART

An electrical lock apparatus includes a key provided with a chip and an input socket touched with a head of the key to read an electronic code input in the chip and perform the electronic operation to unlock the lock apparatus if the read electronic code is equal to a previously input code.

The present invention relates to a head of a key and an input socket touched with the head in the lock apparatus.

A conventional lock apparatus, as shown in FIG. 1, includes a key 10 designed to allow a user to catch it, and a key head 20 provided at the front of the key 10. The key head 20 is provided with a chip, and an electronic code is stored in the chip. The chip is connected with two terminals extended to the key head 20. The key head 20 is inserted into a groove 40 of an input socket 30. Two terminals of the key head 20 are in contact with the two terminals extended to the input socket 30, so that the electronic code input in the chip of the key head 20 is read in the input socket 30. The read information is transferred to a PCB of the input socket 30 to determine whether the code is right. If the code is right, the lock apparatus is unlocked.

The aforementioned lock apparatus has a structure in which a protrusion 10a is protruded in the key 10, is inserted into a portion of the lock apparatus, and is turned to only if the code is right, thereby unlocking the lock apparatus. To this end, since the protrusion 10a should be formed in the key 10, the size of the key 10 is required at a certain range. Also, since the portion engaged with the protrusion 10a should be formed in the input socket, there is limitation in reducing the size of the input socket.

### DISCLOSURE OF INVENTION

### Technical Problem

The present invention has been made to solve the above-mentioned problems occurring in the prior art, and an object of the present invention is to give an electrical lock apparatus in which protrusions are formed at constant angles in a head of a key and grooves are formed in an input socket to correspond to the protrusions, whereby the input socket can be rotated by turning the key.

### Technical Solution

In an electric lock apparatus including a key having a key head provided with inner and outer terminals of a hemispherical shape, and an input socket into which the key head is inserted, having grooves provided with terminals being in contact with the inner and outer terminals of the key head, the electric lock apparatus comprises protrusions formed to surround the key head, and grooves formed at the grooves of the input socket to allow the protrusions to be respectively inserted thereinto, whereby the input socket is rotated as the key is rotated in a state that the key head is inserted into the input socket.

The protrusions are formed at constant intervals of 60 degree.

Further, the key head is manufactured by insert ejection in a state that a chip is connected with a PCB and the outer and inner terminals are connected with one another.

Further, the inner terminals are protruded toward the center front, and the outer terminals are spaced apart from the inner terminals and laterally protruded.

### Advantageous Effects

In an electrical lock apparatus according to the present invention, since protrusions are formed in a key head and grooves into which the protrusions are inserted are formed in an input socket, the input socket can be rotated by turning a key in a state that the lock apparatus is electrically unlocked through the key head, whereby the lock apparatus is mechanically unlocked.

Further, since the protrusions may not be formed in the key, it is easy to design a shape of the key and obtain a small sized key.

Moreover, since the electric lock apparatus is manufactured by insert ejection in a state that a PCB and a chip are all inserted into the key head, it is possible to obtain a small sized key.

### BRIEF DESCRIPTION OF THE DRAWINGS

FIG. 1 is a perspective view illustrating a related art electrical lock apparatus;

FIG. 2 is a perspective view illustrating an electrical lock apparatus according to the present invention;

FIG. 3 is a front view illustrating an electrical lock apparatus according to the present invention;

FIG. 4 is a sectional view taken along line IV-IV shown in FIG. 3;

FIG. 5 is an exploded perspective view illustrating a key head of an electrical lock apparatus according to the present invention;

FIG. 6 is a front view illustrating an input socket of an electrical lock apparatus according to the present invention; and

FIG. 7 is a sectional view taken along line VI-VI shown in FIG. 6.

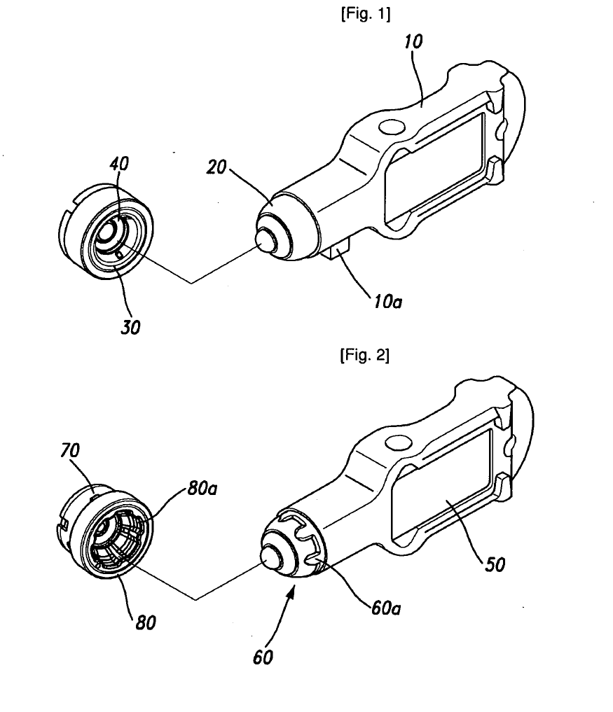

### BEST MODE FOR CARRYING OUT THE INVENTION

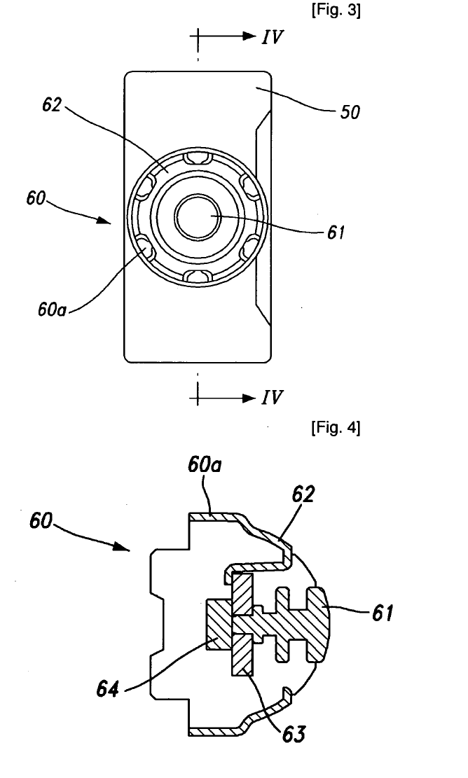

An electrical lock apparatus according to the present invention, as shown in FIG. 2, includes a key head 60 formed at the front of a key 50, wherein the key head 60 has a hemispherical shape. Protrusions 60a are formed at the rear of the key head 60 at constant intervals of 60 degree. The protrusions 60a are formed at a constant thickness and their foremost fronts are pointed. The key head 60 is in contact with an input socket 70 provided with a hemispherical groove 80 into which the key head is inserted. The hemispherical groove 80 is provided with grooves 80a corresponding to the protrusions 60a so that the protrusions 60a can be inserted into the grooves 80a. Each groove 80a has a width greater than that of each protrusion 60 to form a gap. Accordingly, a user can rotate the input socket 70 along rotation of the key head 60 by inserting the key head 60 into the groove 80 of the input socket 70 while holding the key with its hand, and turning the key head 60 to allow the protrusions 60a to be inserted into the grooves 80a. Of course, the input socket 70 can be rotated only if an electronic code input in a chip of the key head 60 is right.

FIG. 3 is a front view illustrating the key head 60. Referring to FIG. 3, an inner terminal 61 is externally protruded at the center of the key head 60. An insulating material is formed to surround the inner terminal 61, and an outer terminal 62 is provided around the insulating material.

A connection structure of these terminals is shown in FIG. 4. Referring to FIG. 4, a PCB 63 is provided at the center of the key head 60, and an IC chip 64 is provided below the PCB 63. The inner terminal 61 is connected with the PCB 63 through the center while the outer terminal 62 is protruded toward its periphery and then electrically connected with the PCB 63. Accordingly, when the inner terminal 61 and the outer terminal 62 are respectively in contact with inner terminals 81 and 83 and an outer terminal 82 of the input socket, it is possible to unlock the lock apparatus by turning the input socket 70.

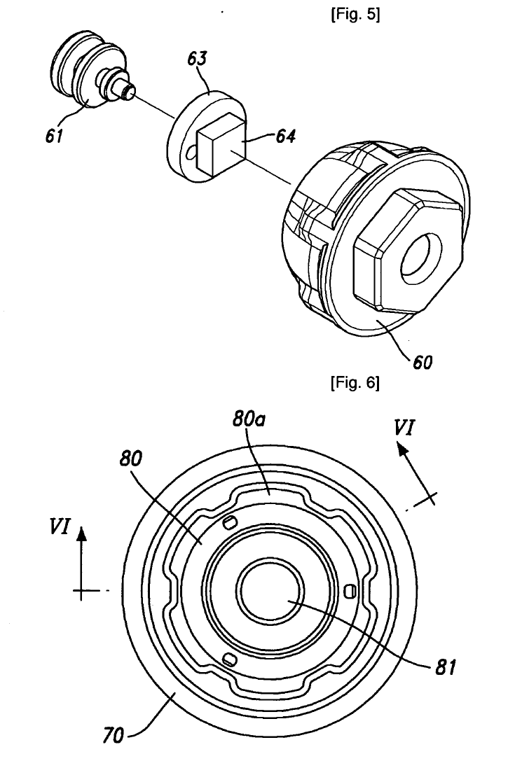

The manufacture process of the key head 60 will be described with reference to an exploded perspective view of FIG. 5. In a state that the inner terminal 61 is in contact with the PCB 63, the outer terminal 62 is connected with the PCB 63, whereby an assembly is formed. The assembly is inserted into a die and plastic constituting an insulator is supplied to the die, so that the assembly is manufactured by insert ejection. In this way, a small sized chip 64 is manufactured such that all parts are inserted into the head 60 to enable insert ejection. In this case, a smaller sized key can be obtained.

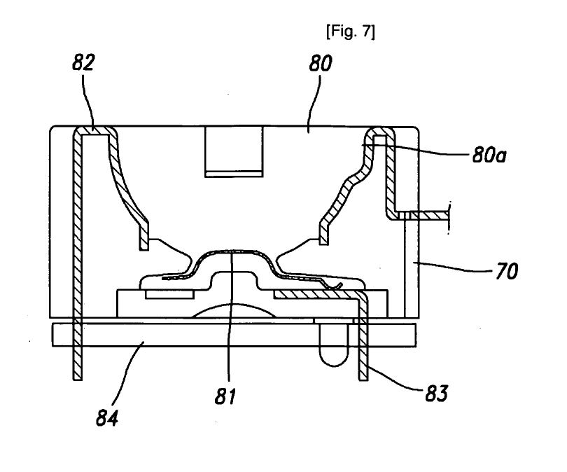

The input socket 70 is shown in FIGS. 6 and 7. FIG. 6 is a front view illustrating the input socket 70 to view the inside of the groove 80 well. The hemispherical groove 80 is formed to allow the key head 60 to be inserted into the input socket 70. Six grooves 80a are formed at constant intervals of 60 degree to allow the protrusions 60a of the key head 60 to be inserted into the groove 80.

Referring to FIG. 7, a contact member 81 of a plate spring structure connected with the inner terminal 83 is attached to the inner terminal 83 at the center of the groove of the input socket 70. The inner terminal 83 is downwardly extended to be electrically connected with a PCB 84. The outer terminal 82 is spaced apart from the contact member 81 and extended to the side of the groove 80 of the input socket 70. Of course, an end of the outer terminal 82 is connected with the PCB 84. Accordingly, if the key head 60 is inserted into the inner terminals 81 and 83, it is possible to make a smooth contact between the key head 60 and the inner terminals 81 and 83 using elasticity of a spring.

In the aforementioned electrical lock apparatus, if the terminals are in contact with one another as the key head 60 is inserted into the groove 80 of the input socket 70, the PCB 84 identifies whether the code is right. The key head 60 is configured to rotate the input socket 70 only if the code is right. In this case, the protrusions 60a of the key head 60 are inserted into the grooves 80a of the input socket 70, the input socket 70 is rotated along rotation of the key head 60.

### INDUSTRIAL APPLICABILITY

The electrical lock apparatus according to the present invention can usefully be used for an electric key of a large sized locker room.

1. In an electric lock apparatus including a key having a key head provided with inner and outer terminals of a hemispherical shape, and an input socket into which the key head is inserted, having grooves provided with terminals being in contact with the inner and outer terminals of the key head, the electric lock apparatus comprising:
protrusions formed to surround the key head; and
grooves formed at the grooves of the input socket to allow the protrusions to be respectively inserted thereinto, whereby the input socket is rotated as the key is rotated in a state that the key head is inserted into the input socket.

2. The electric lock apparatus as claimed in claim 1, wherein the protrusions are formed at constant intervals of 60 degree.

3. The electric lock apparatus as claimed in claim 1, wherein the key head is manufactured by insert ejection in a state that a chip is connected with a PCB and the outer and inner terminals are connected with one another.

4. The electric lock apparatus as claimed in claim 3, wherein the inner terminals are protruded toward the center front, and the outer terminals are spaced apart from the inner terminals and laterally protruded.
